(19) United States
(12) Patent Application Publication
(10) Pub. No.: US 2013/0291439 A1
(43) Pub. Date: Nov. 7, 2013

(54) SENSOR UNIT AND METHOD FOR CONTACTLESSLY ACTUATING A VEHICLE DOOR

(71) Applicant: BROSE FAHRZEUGTEILE GMBH & CO. KG, HALLSTADT, HALLSTADT (DE)

(72) Inventors: HOLGER WUERSTLEIN, ZEIL AM MAIN (DE); ANDRE GUNREBEN, HALLSTADT (DE)

(21) Appl. No.: 13/939,642

(22) Filed: Jul. 11, 2013

Related U.S. Application Data
(63) Continuation of application No. PCT/EP2011/006569, filed on Dec. 24, 2011.

(30) Foreign Application Priority Data
Jan. 11, 2011 (DE) 10 2011 008 277.8

(51) Int. Cl. E05F 15/20; G01V 3/12

(52) U.S. Cl. CPC E05F 15/2023; G01V 3/12
USPC 49/357; 324/647

(57) ABSTRACT

A capacitive sensor unit is disposed for contactlessly actuating a vehicle door. The sensor unit has an electrode assembly with at least three electrodes that are disposed in a spaced relationship. The electrodes include a first transmitting electrode, a second transmitting electrode, and a receiving electrode arranged between the two transmitting electrodes.

### CROSS-REFERENCE TO RELATED APPLICATION

This application is a continuation, under 35 U.S.C. §120, of copending international application No. PCT/EP2011/006569, filed Dec. 24, 2011, which designated the United States; this application also claims the priority, under 35 U.S.C. §119, of German patent application No. DE 10 2011 008 277.8, filed Jan. 11, 2011; the prior applications are herewith incorporated by reference in their entirety.

### BACKGROUND OF THE INVENTION

### Field of the Invention

The invention relates to a sensor unit for contactlessly actuating, that is say for opening or closing, a vehicle door, in particular a tailgate.

For a user of a vehicle it is, under certain circumstances, desirable to open or close a vehicle door, in particular the tailgate of a passenger trunk, contactlessly. Such a requirement applies to a particular degree when, inter alia, the vehicle is loaded or unloaded and the user uses both hands to carry an object such as, for example, a beverage crate.

Recently, devices for contactlessly actuating a tailgate have become known which detect, by way of capacitive measuring technology, a specific movement of the leg of a vehicle user, for example a foot movement in the direction of or under the rear bumper of the vehicle, as a door opening request, and subsequently bring about the automatic opening of the tailgate.

Such a device is described, in particular, in Patent Application Publication Pub. No. US 2011/0276234 A1 and its counterpart German patent application DE 10 2008 063 366 A1. There, the device comprises two capacitive proximity sensors which are spaced apart from one another, and a control unit for evaluating the capacitive measuring signals. The two proximity sensors sense two separate detection areas, wherein the tailgate is actuated only if the approach of a body part is detected in both detection areas.

In order to measure capacitances and the changes therein, typically what is referred to as the “charge transfer method” is used in capacitive proximity sensors. For this purpose, a sensor electrode is charged electrically and connected in parallel with a reference capacitor. The voltage which is applied to the reference capacitor is used for evaluation. The “charge transfer method” is defined by a high level of accuracy but is comparatively time-consuming and energy-intensive.

The capacitive proximity sensors which are generally used usually measure the capacitance formed between a sensor electrode, on the one hand, and ground, on the other. However, the measurement of capacitance with respect to ground is disadvantageous for the area of application of contactless actuation of a vehicle door. The vehicle bodywork parts which are grounded and which are directly adjacent to the sensor unit form in fact a comparatively large basic capacitance which makes it more difficult to measure a very small change in capacitance such as is typically caused by the presence of a body part in the detection range of the sensor unit. The basic capacitance is usually reduced by the installation of a “driven shield”, which shields the vehicle ground from the sensor electrode. However, a “driven shield” decreases the detection range of the capacitive proximity sensor, which is in turn disadvantageous for the reliable detection of a door opening request which is indicated by a movement of a leg.

German published patent application DE 10 2009 025 212 A1 describes a further device for contactlessly actuating a tailgate. The apparatus comprises a capacitive proximity sensor with two electrodes between which a third electrode, which is electrically connected to the ground of the vehicle, is arranged. That electrode configuration permits the capacitance of the two outer electrodes to be measured with respect to one another without requiring an additional reference capacitance for this purpose. In that device, the two electrodes of the capacitive sensor are electrically charged and discharged periodically. In the context, the profile of the electrical voltage which is present between the electrodes is evaluated by means of a control unit. If the voltage reaches a predefined threshold value, a signal which actuates the vehicle door is output by the control unit.

### BRIEF SUMMARY OF THE INVENTION

It is accordingly an object of the invention to provide a sensor unit and a corresponding method which overcome the above-mentioned disadvantages of the heretofore-known devices and methods of this general type and which provides for an efficient sensor unit that is not susceptible to faults for the purpose of contactlessly actuating a vehicle door and a vehicle with the sensor unit. The invention is also based on the object of specifying an improved method for contactlessly actuating a vehicle door by way of such a sensor unit.

With the foregoing and other objects in view there is provided, in accordance with the invention, a capacitive sensor unit for contactlessly actuating a vehicle door of a vehicle, comprising:

an electrode configuration mounted to the vehicle and disposed for contactless actuation of the vehicle door;

the electrode configuration having at least three, mutually spaced-apart electrodes, the electrodes including a first transmitting electrode, a second transmitting electrode, and a receiving electrode disposed between the first and second transmitting electrodes.

In other words, the objects of the invention are achieved by the novel capacitive sensor unit, by a vehicle containing the novel sensor unit, and also by the claimed method of contactlessly actuating a vehicle door by such a sensor unit.

The capacitive sensor unit according to the invention comprises a three-part electric configuration having two transmitting electrodes and a receiving electrode which is arranged therebetween, at a spacing distance therefrom.

In the sensor unit, qualitative capacitance values between the transmitting electrodes and the receiving electrode are detected, wherein a reference capacitance, such as is used in the charge transfer method, is no longer required. The operation of the sensor unit is therefore time-consuming and energy-saving. Coupling of the sensor unit to a “driven shield” or the like for the purpose of shielding from the vehicle ground is therefore not necessary either.

During the operation of the sensor unit, an electrical leakage field or detection field is irradiated into the surrounding space by the transmitting electrodes in the way which is typical of capacitive sensors. The detection field defines a detection range around the sensor unit. The term “detection range” generally refers to the measurement-sensitive range of the sensor unit, that is to say that range within which the sensor unit can detect the approach of a vehicle user. The electrical leakage field is influenced in a way which can be measured by the body tissue of the vehicle user as he approaches.

Through the combination of two transmitting electrodes with a common receiving electrode, two component detection ranges are formed here in a resource-saving manner which permit a doubled proximity measurement. The redundancy of the detection ranges permits the foot movement which indicates the door opening request to be differentiated from other proximity signals, for example the signal which is caused by a cat brushing the bumper as it moves past. In addition to the pure redundancy effect, the configuration of the two locally offset detection fields also results in additional information here which has clearly reduced the risk of incorrect triggering. In particular, the sequence and signal strength in which an approach in each of the two detection fields is detected allows the type of detected object to be inferred. Therefore, the lower detection range is mainly triggered, for example, in response to a cat running under the motor vehicle, while the upper detection range is not influenced or is only influenced weakly. In contrast, when a human leg approaches (door opening request) both detection fields are influenced. However, in the upper detection range the approaching of the leg is detected earlier than in the lower detection range.

Basically, instead of the combination of two transmitting electrodes with a common receiving electrode it is also equally possible to use a combination of two receiving electrodes with a common transmitting electrode.

In accordance with a preferred feature of the invention, the vehicle door is a tailgate. In a suitable installation situation, the sensor unit can in this case be expediently arranged on or, for visual reasons preferably, inside a motor vehicle bumper. The last-mentioned variant has the additional advantage that the sensor unit is protected against external influences, in particular against weather effects. However, the sensor unit according to the invention can basically also be used for contactlessly actuating other vehicle doors. However, in any case the sensor unit is preferably arranged on or inside the vehicle, in a region near the vehicle door to be actuated.

In one advantageous embodiment, when the electrode elements are installed in the bumper they extend essentially over the entire width thereof. In this context, transmitting and receiving electrodes are suitably arranged in parallel along the longitudinal direction of the bumper. As a result, the sensor unit covers a large detectable area.

In one preferred form of installation, a first transmitting electrode and the receiving electrode are embodied as flat conductors, and the second transmitting electrode is embodied as a round conductor, wherein the first transmitting electrode is arranged, in particular, above the second transmitting electrode. This embodiment of the transmitting electrodes brings about, in the detection range assigned to the first transmitting electrode, a comparatively directed, narrow design of the associated detection field, while the detection field which is associated with the second transmitting electrode is fanned out in a wider fashion, i.e. to a greater extent. This combination of different detection field geometries is advantageous, in particular, for the arrangement of the electrodes in the vehicle bumper.

In accordance with again an added feature of the invention, the first transmitting electrode and the receiving electrode are integrated in a common, preferably extruded, combined flat conductor electrode.

In accordance with an expedient feature of the invention, the electrodes are composed of individual lines which are arranged in the form of loops. Through opposing orientation of the winding of the transmitting electrodes, on the one hand, and of the receiving electrode, on the other hand, an approximately equal distribution of capacitance is achieved along the surface which is spanned by the electrodes.

In one advantageous embodiment, the sensor unit comprises a control unit for generating an electrical transmission signal which is fed to the transmitting electrodes, and for evaluating an electrical reception signal which is received by the receiving electrode. The signals which are transmitted and received by the control unit are expediently alternating voltages. The control unit is formed, in particular, by a microcontroller with control software implemented therein, or comprises at least one such microcontroller, alongside other analog or digital circuit elements.

In the case of the electrode configuration described above, in which the transmitting electrodes, on the one hand, and the receiving electrode, on the other, are formed by conductor loops which are wound in opposite directions, the control unit is preferably arranged between the two transmitting electrodes. If the electrodes are mounted on or integrated or in the vehicle bumper, the control unit is also expediently integrated on or in the bumper at the same time. In the case of this approximately symmetrical arrangement of the control unit near to the electrodes, the electrodes are expediently connected directly to the control unit. Electrical feed lines between the electrodes and the control unit, which would have to be shielded at high cost or could otherwise falsify the measurement result, become superfluous in this way and are correspondingly preferably not provided either.

In accordance with a further advantageous embodiment of the invention, the control unit is embodied in terms of circuitry and/or programming such that it generates the transmission signal from two component signals which are phase-shifted with respect to one another, in particular by a phase angle of 90°, transmits this combined transmission signal to the transmitting electrodes and forms a difference signal from the corresponding component signals of a reception signal which is received by the receiving electrode. In this context, the control unit outputs a triggering signal when the difference signal meets a predefined (triggering) criterion. In particular a threshold value comparison is provided here as the triggering criterion, in the course of which comparison the control unit compares the difference signal with a stored threshold value and generates the triggering signal when the threshold value is exceeded.

With the above and other objects in view there is also provided, in accordance with the invention, a method of contactlessly actuating a vehicle door of a vehicle, which comprises:

providing the vehicle with a sensor unit as summarized above;

generating a transmission signal composed of two component signals that are phase-shifted with respect to one another, and transmitting the transmission signal to the transmitting electrodes;

decomposing a reception signal that is received by the receiving electrode into two corresponding component signals;

forming a difference signal from the component signals of the reception signal; and

if the difference signal meets a predefined triggering criterion, outputting a triggering signal to bring about an actuation of the vehicle door.

The method described above builds on the technology known from data transmission as “IQ modulation”. In the case of conventional “IQ modulation,” a data stream is modulated onto each of the two component (carrier) signals in a transmitting station. The two data streams, generally different data streams, are then demodulated from the respective component (carrier) signal after separation of the two component signals in a receiving station. The IQ modulation thus permits two-channel transmission of information by means of a common signal. However, in contrast to this known technology, in the case of the method which is preferred according to the invention no information is modulated onto the component signals by the control unit. The two component signals are merely modified in the field space, that is to say between the emission via the transmitting electrode and the reception by the receiving electrode by means of the physical material of a vehicle user who is possibly present, wherein both component signals experience an identical change in phase here. The method utilizes here the fact that, owing to the difference in phase between the two component signals, the change in phases which is caused in the field space is expressed with different signs in the respective real part of the two component signals. In the difference signal, the change in phase is therefore mapped to an amplified degree, while fluctuations in the component signals which are caused by noise are reduced statistically in the difference signal. The use of the two component signals therefore provides an improved signal-to-noise ratio with simple means.

In order to be able to separate the reception signal from the two transmitting electrodes easily, there is provision in one advantageous development that during the transmission of the transmission signal the control unit changes between the transmitting electrodes in a chronologically alternating fashion. At each point in time, the control unit therefore always acts on just one of the two transmitting electrodes, with the result that the reception signal also always originates only from one of the two transmitting electrodes at any point in time.

In order to rule out the residual risk of incorrect triggering of the sensor unit due to unauthorized persons or, for example, animals, the sensor unit is preferably coupled to a fully automatically opening door lock system (“Keyless Go”) which enables actuation of the vehicle door only when the door lock system is unlocked, for example by a radio transmitter in the vehicle user's key.

Other features which are considered as characteristic for the invention are set forth in the appended claims.

Although the invention is illustrated and described herein as embodied in a sensor unit for contactlessly actuating a vehicle door, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic elevation view of a bumper of a motor vehicle having a capacitive sensor unit for contactlessly actuating a motor vehicle tailgate, wherein the sensor unit comprises two transmitting electrodes, a common receiving electrode and a control unit;

FIG. 2 is an illustration similar to FIG. 1 of an embodiment of the sensor unit in which the receiving electrode is integrated with one of the transmitting electrodes in a common flat conductor;

FIG. 3 is an illustration similar to FIG. 1 of an embodiment of the sensor unit in which the transmitting electrodes and the receiving electrode are embodied as loop-shaped individual conductors, wherein the loops of the transmitting electrodes, on the one hand, and of the receiving electrode, on the other hand, have an opposing winding direction;

FIG. 4 is a schematic side view of the bumper with the sensor unit arranged therein, together with an electrical leakage field which is embodied between the transmitting electrodes and the receiving electrode;

FIG. 5 is a complex vector diagram (i.e., mapping the complex numerical plane) of two component signals, which are phase-shifted by 90°, of a transmission signal which is emitted to the transmitting electrodes by the control unit;

FIG. 6 is an illustration according to FIG. 5 of two corresponding component signals of a reception signal which is received by the receiving electrode;

FIG. 7 is a chronological diagram of the profile of a first component signal (I channel, illustrated in inverted form here) and of a second component signal (Q channel) of the reception signal and of a difference signal derived therefrom; and

FIG. 8 is a roughly schematic side view of a rear part of a motor vehicle which is provided with a sensor unit for contactlessly actuating the tailgate, and a leg of an approaching vehicle user.

### DESCRIPTION OF THE INVENTION

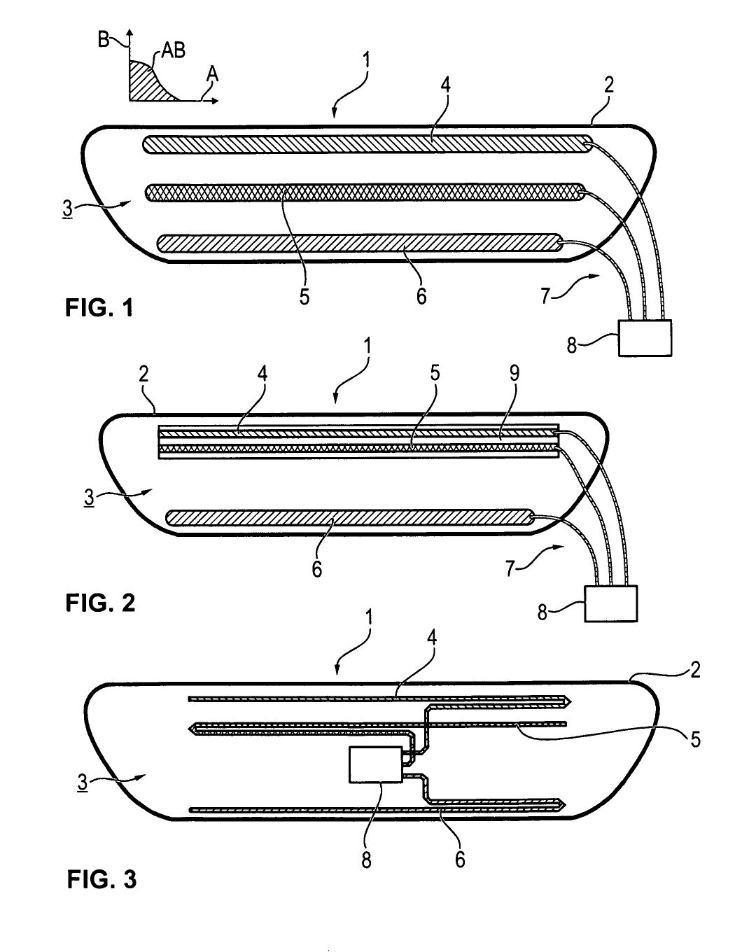

Reference is now had to the figures of the drawing, where corresponding parts and variables are identified with the same reference symbols throughout. FIGS. 1 to 3 show various embodiments of a capacitive sensor unit 1 which is arranged inside a (motor vehicle) bumper 2. An electrode configuration 3 of the sensor unit 1 comprises a first transmitting electrode 4, a receiving electrode 5 and a second transmitting electrode 6. The electrode configuration 3 is connected to a control unit 8 via electric feed lines 7 (i.e., FIGS. 1 and 2). In the embodiments according to FIGS. 1 and 2, the feed lines 7 are equipped with a shield against electromagnetic interference fields, as a result of which it is possible to move the control unit 8 from the area of the bumper 2 which is subjected to weather influences into the dry space of the associated motor vehicle.

The electrodes 4, 5 and 6 of the sensor unit 1 extend parallel to a longitudinal direction A of the bumper, substantially over an entire width of the bumper 2. The electrodes 4, 5 and 6 are located spaced apart from one another in an electrode plane AB which is spanned by the longitudinal direction A of the bumper and a transverse direction B of the bumper. The receiving electrode 5 is arranged here between the transmitting electrodes 4 and 6, in each case at a distance from the latter.

In the exemplary embodiment according to FIG. 1, the first transmitting electrode 4 and the receiving electrode 5 are each embodied as separate flat conductors. The second transmitting electrode 6 can also be formed by a flat conductor. This second transmitting electrode 6 is, however, preferably embodied as a round conductor in order to bring about wider fanning out of the associated detection field.

The exemplary embodiment according to FIG. 2 differs from the exemplary embodiment described above in that the transmitting electrode 4 and the receiving electrode 5 are integrated together in an extruded flat conductor strip 9 in said figure. The second transmitting electrode 6 is, on the other hand, preferably embodied as a round conductor, as in the embodiment according to FIG. 1.

In the embodiment shown in FIG. 3, the electrodes 4, 5 and 6 are each formed by an individual line, in particular with a round cross section, wherein these individual lines are each laid in the form of an open loop in the plane AB of the electrode. The winding direction of the conductor loop which forms the receiving electrode 5 is oriented in the opposite direction to the winding direction of the conductor loops which form the transmitting electrodes 4 and 6 here.

In the electrode configuration according to FIG. 3, the electrodes 4, 5 and 6 are connected to the control unit 8 directly, in particular without intermediately connected, if appropriate shielded feed lines 7, said control unit 8 being arranged here between the transmitting electrodes 4 and 6 in the middle of the surface spanned by the latter on or in the bumper 2.

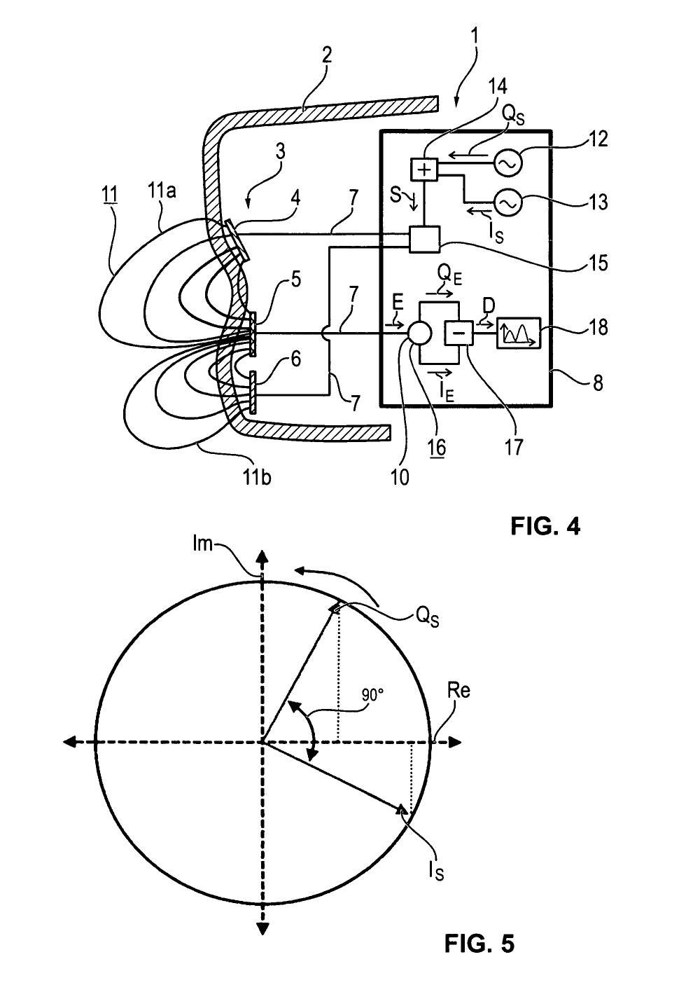

As is illustrated schematically in FIG. 4, the electrodes 4, 5 and 6 are arranged, in particular, inside the bumper 2 for protection against external influences.

During operation of the sensor unit 1, the control unit 8 applies an electrical alternating voltage to the transmitting electrodes 4 and 6, which voltage is referred to below as transmission signal S. Under the effect of this transmission signal S, an electrical leakage field 11 is formed starting from the transmitting electrodes 4 and 6, in a spatial volume which is arranged in front of the bumper 2 and is referred to below as the detection space. In particular a component field 11a of the leakage field 11 extends between the transmitting electrode 4 and the receiving electrode 5, while a further component field 11b of the leakage field 11 extends between the transmitting electrode 6 and the receiving electrode 5.

A shield (not shown) optionally ensures that the leakage field 11 of the electrode configuration 3 is irradiated only into the half-space outside the bumper 2. As a result, the detection space of the sensor unit 1 is restricted essentially to the half-space outside the vehicle bumper 2, which rules out, in particular, the possibility of the sensor unit 1 not being influenced by interference fields from the interior of the vehicle.

The electrode configuration 3 is operated in a time-division multiplex mode in that a switching unit 15 of the control unit 8 alternately always supplies just one of the transmitting electrodes 4 or 6 with the transmission signal S. As a result, the two component fields 11a and 11b can be monitored separately from one another via the common receiving electrode 5.

In the embodiment shown in FIG. 4, the control unit 8 comprises two alternating voltage sources 12 and 13 which generate two component signals, namely, I_{S} (“I channel”) and Q_{S} (“Q channel”) which alternate, in particular, chronologically in a sine shape or cosine shape, phase-shifted with respect to one another by 90°. FIG. 5 shows by way of example the two generated component signals I_{S} and Q_{S} in a vector illustration in the complex numerical plane which is spanned by a real axis Re and a virtual axis Im. The projections of the vector peaks onto the real axis Re correspond here to (measurable) real values of the component signals I_{S} and Q_{S}. These component signals I_{S} and Q_{S} are combined by an adding element 14 to form the transmission signal S and are alternately transmitted to the transmitting electrodes 4 and 6 of the electrode configuration 3 via the switching unit 15.

The receiving electrode 5 is connected to a shunt resistor 10 or some other current converter circuit of the control unit 8 which converts the displacement current, occurring during the operation of the electrode configuration 3, into an electrical voltage, referred to below as reception signal E. The reception signal E is preferably amplified by an amplifier circuit (not explicitly shown) before it is evaluated by the control unit 8.

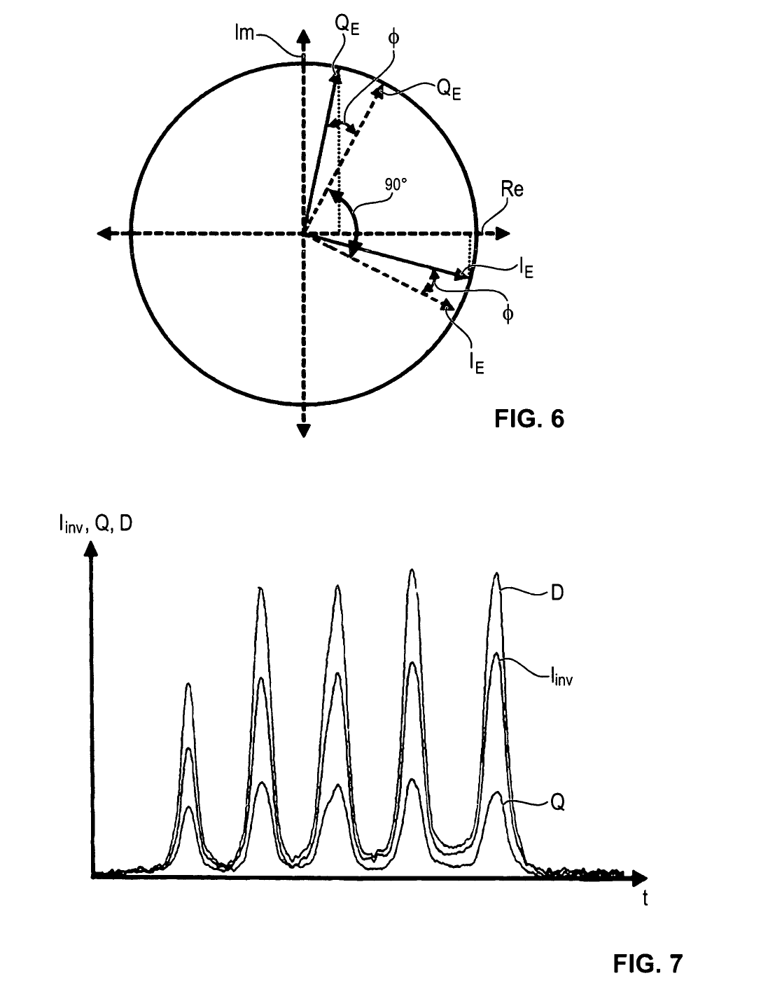

The reception signal E likewise contains the information from the transmitted component signals I_{S} and Q_{S}. In particular, the reception signal E is also composed mathematically of an addition of two sine-shaped or cosine-shaped component signals I_{E} and Q_{E}, which correspond to the I channel and Q channel of the transmission signal S, respectively, and likewise have a phase offset of 90° with respect to one another. The component signals I_{E} and Q_{E} are illustrated in the complex numerical plane in FIG. 6, in a vector illustration corresponding to FIG. 5. By means of a channel divider 16 of the control unit 8, these component signals I_{E} and Q_{E} are extracted from the reception signal E, in a fashion analogous to the technology which is customary in the case of IQ modulation.

Phase offset between the transmission signal S and the reception signal E (proportional to the displacement current flow) is determined from the ratio between the, constant, ohmic resistance and the capacitive reactive resistance of the sensor unit 1. In the steady (undisrupted) state, i.e. in the absence of a body part in the detection space of the sensor unit 1, this ratio is constant, with the result that the phase offset between the transmission signal S and the reception signal E is also chronologically unchanged. In particular, the steady-state reactive resistance can therefore also be compensated by the control unit 8, with the result that the transmission signal S and the (compensated) reception signal E are at least approximately in phase in the steady state. For the steady state, the component signals I_{E} and Q_{E} are illustrated by dashed lines by way of example in FIG. 6.

The capacitance of the electrode configuration 3 is influenced when introducing the body part, for example the leg of a vehicle user, into the leakage field 11. As a result, the capacitive reactive resistance of the sensor unit 1 changes while the ohmic resistance remains constant, as a result of which the phase angle of the reception signal E changes in comparison with the transmission signal S by a phase angle φ. As a result, the phase position of both component signals I_{E} and Q_{E} also changes by the phase angle φ, as is illustrated in FIG. 6 by unbroken lines. Owing to the 90° phase offset between the component signals I_{E} and Q_{E}, the change in phase in the real values of the component signals I_{E} and Q_{E} is, however, expressed in an opposite fashion, as can be seen in FIG. 6. In the illustrated example, the real value of the component signal I_{E} increases owing to the change in phase, while the real value of the component signal Q_{E} decreases.

This effect is utilized by the control unit 8 by sampling the real values of the component signals I_{E} and Q_{E} cyclically in each case at the zero crossover of the excitation voltage S and forming a difference signal D therefrom by means of a differentiator 17. The difference signal D is passed onto a comparator 18 which compares the difference signal D with the stored threshold value and generates triggering signals Sₐₘ and Sₐₛ if the difference signal D exceeds the threshold value. The advantage of the difference formation is here, in particular, the fact that, as is apparent from FIG. 7, the change in phase in the difference signal is amplified owing to the opposed effect of the change in phase on the real values of the two component signals I_{E} and Q_{E}. In other words, as a result of the difference formation of the I channel and Q channel, a stronger change in level is therefore achieved than if just one channel were evaluated. Noise components of the component signals I_{E} and Q_{E} are, in contrast, averaged out statistically by the difference formation.

In a preferred embodiment, the control unit 8 comprises a microcontroller in which a control program which automatically carries out the method described above is implemented. In particular the differentiator 17 and the comparator 18 are preferably implemented as software as parts of the control program. The other specified components of the control unit 8 are preferably implemented by circuitry.

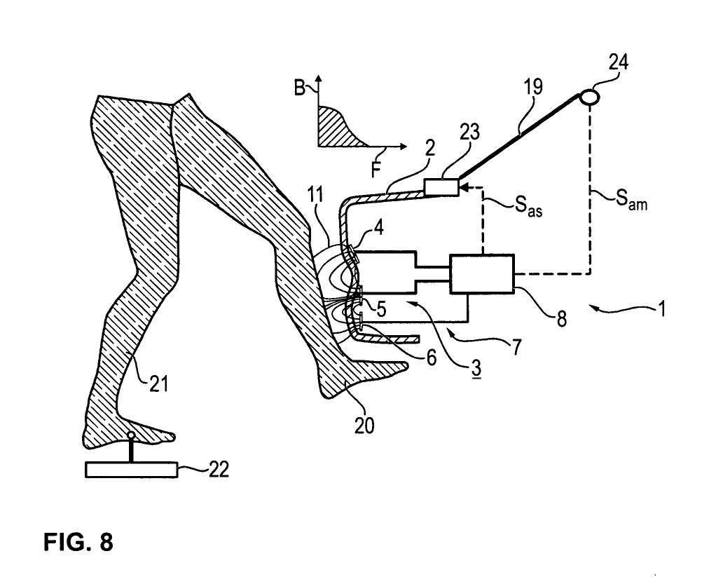

FIG. 8 shows a schematic detail of a rear region of a vehicle during the contactless actuation of a tailgate 19 by means of a leg 20 of a vehicle user. The vehicle user is grounded to the ground 22 by his other leg (standing leg 21). The tailgate 19 is equipped with a door lock 23 and a motor unit 24 for automatically opening and closing.

If the vehicle user moves his leg 20 closer to the bumper 2 in a direction F, the leg 20 moves into the detection space of the sensor unit 1 which is filled by the leakage field 11. The grounded leg 21 acts as an additional electrode by which the capacitance of the electrode configuration 3 is reduced, with the result that the difference signal D (as described above) which is determined in the control unit 8 exceeds the threshold value.

The control unit 8 transmits the subsequently generated triggering signal Sₐₛ to the door lock 23, and the triggering signal Sₐₘ to the tailgate motor 24. As a result of the triggering signals Sₐₛ and Sₐₘ, respectively, the door lock 23 is unlocked and the tailgate motor 24 is activated, as a result of which the tailgate 19 is automatically opened.

The following is a list of reference symbols used in the specification and in the drawings:
1 Sensor unit
2 Bumper
3 Electrode configuration
4 Transmitting electrode
5 Receiving electrode
6 Transmitting electrode
7 Feed line
8 Control unit
9 Flat conductor strip
10 Shunt resistor
11 Leakage field
11a Component field
11b Component field
12 Phase-shifted voltage source
13 Voltage source
14 Adding element
15 Switching unit
16 Channel divider
17 Differentiator
18 Comparator
19 Tailgate
20 Leg
21 Standing leg
22 Ground
23 Door lock
24 Motor unit
A Longitudinal direction of bumper
AB Electrode plane
B Transverse direction of bumper
D Difference signal
E Reception signal
I_{S} Component signal (I channel)
I_{E} Received component signal (I channel)
Im Virtual axis
Q_{E} Received component signal (Q channel)
Q_{S} Component signal (Q channel)
Re Real axis
S Transmission signal
Sₐₛ Lock triggering signal
Sₐₘ Motor triggering signal
S Transmission signal
φ Phase angle

1. A capacitive sensor unit for contactlessly actuating a vehicle door of a vehicle, comprising:
an electrode configuration mounted to the vehicle and disposed for contactless actuation of the vehicle door;
said electrode configuration having at least three, mutually spaced-apart electrodes, said electrodes including a first transmitting electrode, a second transmitting electrode, and a receiving electrode disposed between said first and second transmitting electrodes.

2. The sensor unit according to claim 1, wherein said first transmitting electrode and said receiving electrode are flat conductors and said second transmitting electrode is a round conductor.

3. The sensor unit according to claim 1, wherein said first transmitting electrode and said receiving electrode are integrated in a common flat conductor strip.

4. The sensor unit according to claim 1, wherein said at least three electrodes are formed from loop-shaped individual lines, and wherein a loop winding of said first and second transmitting electrodes is oriented in an opposite direction of a loop winding of said receiving electrode.

5. The sensor unit according to claim 4, which further comprises a control unit connected to said at least three electrodes and arranged between said first and second transmitting electrodes, said control unit being configured for generating a transmission signal for said first and second transmitting electrodes and for evaluating a reception signal received from said reception electrode.

6. The sensor unit according to claim 5, wherein said control unit is configured to transmit the transmission signal in a chronologically alternating fashion to said first transmitting electrode and to said second transmitting electrode.

7. The sensor unit according to claim 1, which further comprises a control unit for generating a transmission signal for said first and second transmitting electrodes and for evaluating a reception signal received by said receiving electrode; and
wherein said control unit is configured to:
generate the transmission signal from two component signals that are phase shifted with respect to one another;
decompose the reception signal into two corresponding component signals;
form a difference signal from the component signals of the reception signal; and
output a triggering signal bringing about the actuation of the vehicle door when the difference signal meets a predefined triggering criterion.

8. The sensor unit according to claim 7, wherein said control unit is configured to transmit the transmission signal in a chronologically alternating fashion to said first transmitting electrode and to said second transmitting electrode.

9. A vehicle, comprising a vehicle door and a sensor unit according to claim 1 for contactlessly actuating said vehicle door.

10. The vehicle according to claim 9, wherein said vehicle door is a tailgate of a motor vehicle.

11. The vehicle according to claim 9, which further comprises a vehicle bumper and wherein said sensor unit is arranged on or inside said vehicle bumper.

12. The vehicle according to claim 11, wherein said at least three electrodes of said electrode configuration extend substantially over a entire width of said bumper parallel to a bumper longitudinal direction.

13. A method of contactlessly actuating a vehicle door of a vehicle, which comprises:
providing the vehicle with a sensor unit according to claim 1;
generating a transmission signal composed of two component signals that are phase-shifted with respect to one another, and transmitting the transmission signal to the transmitting electrodes;
decomposing a reception signal that is received by the receiving electrode into two corresponding component signals;
forming a difference signal from the component signals of the reception signal; and
if the difference signal meets a predefined triggering criterion, outputting a triggering signal to bring about an actuation of the vehicle door.
